(19) United States
(12) Patent Application Publication
(10) Pub. No.: US 2008/0252483 A1
(43) Pub. Date: Oct. 16, 2008

(54) Radio frequency transponders embedded in surfaces

(75) Inventor: Jan N. Hodges, Fernley, NV (US)

Correspondence Address: BANNER & WITCOFF, LTD., 1100 13th STREET, N.W., SUITE 1200, WASHINGTON, DC, 20005-4051, US

(73) Assignee: Science Applications International Corporation, San Diego, CA (US)

(21) Appl. No.: 11/783,673

(22) Filed: Apr. 11, 2007

(51) Int. Cl. G08G 1/09

(52) U.S. Cl. 340/905; 222/199; 361/679

(57) ABSTRACT

Objects containing radio frequency transponders, such as RFID tags, can be encoded with information and mixed with a substance. The mixed objects and substance can be applied to a surface such as a road, such that a vehicle traveling over the surface may later read encoded information stored in the transponders. In one variation, the objects may include spherical marbles that are mixed with asphalt and embedded in a road surface. An apparatus includes components arranged to receive multiple objects, encode transponders contained in the objects, and mix them with a substance such as asphalt or concrete. Objects may include spheres having helical antenna elements or antenna elements formed on an outer surface thereof. A vehicle may be configured with a reader and antennas arranged to read transponders embedded in a roadway surface.

### CROSS REFERENCE TO RELATED APPLICATIONS

This application is generally related in subject matter to U.S. application Ser. No. 11/527,568, entitled “Radio Frequency Transponders Having Three-Dimensional Antennas,” filed on Sep. 27, 2006, the contents of which are hereby incorporated by reference.

### BACKGROUND

The technology relates generally to radio frequency transponders such as Radio Frequency Identification (RFID) tags having antennas for receiving and/or transmitting signals in close proximity thereof.

So-called RFID transponders or “tags,” which provide self-powered communication and data storage capabilities, are well known. The tags are small and can be attached to various articles such as documents, clothing, and articles to be sold (e.g., groceries or electronic equipment). Each tag wirelessly communicates with a transceiver (referred to as a reader) through a small flat antenna coupled to the tag and fixed to the article. The flat antenna and small size of the tag combine to provide a low-cost, non-intrusive yet highly accurate way to track individual articles. The reader transmits a signal that both powers the RFID tag (when received through the antenna) for the short period of time during which a microprocessor in the chip operates, and causes the RFID tag to transmit a response containing, for example, a unique identifier and/or other information stored in a memory of the RFID tag. The reader can use the received information in various ways, such as for inventory tracking purposes.

One possible application for this technology involves exchanging information with vehicles that travel over a surface, such as an asphalt road. For example, RFID tags could be embedded in a road surface in order to communicate with vehicles that travel over the surface. The U.S. and Canadian governments have expressed interest in using RFID tags for purposes such as tracking vehicles and for monitoring the construction history of a roadway. However, to the inventor's knowledge no practical system for such uses has been proposed.

Other possible applications include embedding radio frequency transponders in various types of surfaces such as buildings, furniture, and the like.

### SUMMARY

One embodiment relates to a method for encoding radio frequency transponders with information and embedding the transponders in a surface such as an asphalt road. Information such as the date of manufacture of asphalt can be encoded onto the transponders. The transponders are embedded in objects such as marbles or cubes having antenna patterns that permit signals to be transmitted and received regardless of the orientation of the objects. The objects are mixed with asphalt or other malleable materials and applied to a surface, such as a roadway. Thereafter, information encoded in the transponders can be read by vehicles traversing the roadway using readers attached to the vehicles.

Another embodiment relates to an object containing a radio frequency transponder suitable for embedding in a surface, such as a roadway. In one variation, the object comprises a sphere having embedded therein the radio frequency transponder and an antenna pattern formed generally along an inside or outer surface of the sphere such that the transponder can send and receive signals regardless of the orientation of the sphere after it has been embedded in a surface.

Yet another embodiment relates to a method for creating objects having radio frequency transponders that can be embedded into a surface, such as a roadway. In one variation, spheres of a solid plastic are cut in half, and grooves are formed in each half corresponding to an antenna pattern. The grooves are filled with foil or wire to create the antenna. A radio frequency transponder is inserted in one half and coupled to the antenna patterns. The two halves are then adhered to each other to form the object. A protective coating is then optionally applied to the surface to prevent degradation by heat, such as hot asphalt.

Yet another embodiment relates to a method for creating objects having radio frequency transponders that can be embedded into a surface. A radio frequency transponder is placed in a mold with antenna terminals, and a resin or other substance is injected into the mold, creating a shape that hardens. The hardened shape can be embedded into various solids, such as concrete, and later read using a reading device.

Yet another embodiment relates to a vehicle equipped with a reader and antennas mounted so as to read radio frequency transponders embedded in a surface, such as a roadway. As the vehicle moves along the roadway, it activates transponders embedded in the roadway so as to read and possibly store information back into the embedded transponders.

Other embodiments and variations will be apparent upon reading the detailed description set forth below, and the invention is not intended to be limited in any way by this brief summary.

### BRIEF DESCRIPTION OF THE DRAWINGS

FIG. 1 shows a system and method for encoding radio frequency transponders and embedding them into a surface, such as a roadway.

FIG. 2 shows details of a rate controller/indexer that can be used in the system and method of FIG. 1.

FIG. 3 shows one possible arrangement of transponder spacing in roadway lanes.

FIG. 4 shows one possible orientation of transponders with respect to vehicle-equipped antennas and readers for reading information from the transponders and a vehicle equipped with such readers.

FIG. 5 shows an object suitable for embedding in a surface, such as an asphalt roadway, wherein the object includes a radio frequency transponder and an antenna.

FIG. 6 shows another embodiment of an object suitable for embedding in a surface, wherein the object includes a radio frequency transponder and an antenna pattern that is etched or applied along an outer surface of the object.

FIG. 7 shows further details of antenna patterns and coupling mechanisms for coupling a transponder to the antennas.

FIG. 8 shows additional details of antenna patterns and coupling mechanisms for coupling a transponder to the antennas.

FIG. 9 shows a first method of creating an object containing a radio frequency transponder and an antenna pattern.

FIG. 10 shows a second method of creating an object containing a radio frequency transponder and an antenna pattern.

### DETAILED DESCRIPTION OF THE INVENTION

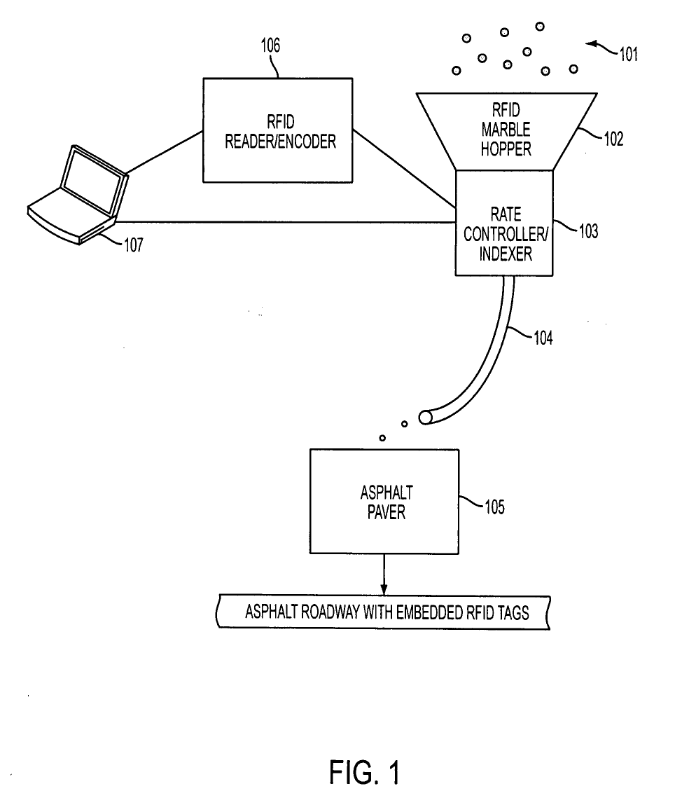

FIG. 1 shows a method and system for encoding radio frequency transponders and embedding them into a surface, such as a roadway, according to various embodiments of the invention. As shown schematically in FIG. 1, a plurality of marble-shaped objects 101 containing radio frequency transponders are conveyed into a hopper 102, such as from a conveyor belt (not shown) or other delivery mechanism. The hopper feeds the objects into a rate controller/indexer 103, which regulates the flow of the objects, such as in response to forward movement of an asphalt paver, and is coupled to a reader/encoder 106. A computer 107, such as a notebook computer or paver mounted controller, controls the operation of reader/encoder 106 and rate controller/indexer 103.

In general, objects containing the transponders are collected in hopper 102, where they are fed into rate controller/indexer 103. While moving through rate controller/indexer 103, the objects are encoded with radio frequency signals by way of antennas from reader/encoder 106. As each object is transported through rate controller/indexer 103, computer 107 in combination with reader/encoder 106 reads identifying information from the transponder within the object (e.g., a unique serial number), encodes certain information into the transponder in the object (for example, information concerning the date and manufacturer of the asphalt), and causes the object to be fed into a feed tube 104.

Feed tube 104 in turn releases the objects into a mixing chamber or device such as asphalt paver 105, where they mix with malleable, liquid, or semi-liquid materials (e.g., asphalt, concrete, polymers, resins, etc.), and are thereafter embedded into such materials. For example, for an embodiment in which the objects are mixed with asphalt, the mixture containing the objects can be used to form a road surface. Because the objects are fed into the mixture in a rate-controlled manner, their distribution along the surface (e.g., a road) can be controlled to be relatively uniform, such that the distance between each embedded object is relatively constant. Moreover, by positioning feed tube 104 over a central feed path portion of asphalt paver 105, the objects can be arranged to be embedded approximately in a center position of a paved lane.

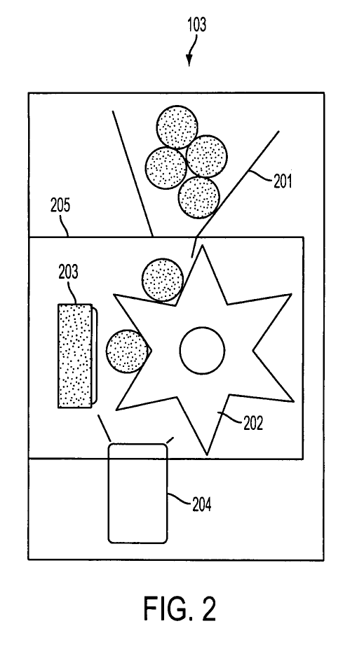

FIG. 2 shows details of one possible rate controller/indexer 103 that can be used in conjunction with the system and method of FIG. 1. The rate controller/indexer includes a narrowing chute 201 that permits only one object at a time to enter the chamber 205. As each object enters the chamber, it comes into contact with an indexing gear 202 that guides it toward an antenna 203 that is coupled to reader/encoder 106 (FIG. 1). As the object reaches a position in front of antenna 203, it is interrogated by reader/encoder 106, causing it to emit information including for example a unique serial number. This information is fed to computer 107, which then records the serial number or other identifying information into a database, along with a time stamp and other pertinent information.

Shortly thereafter, computer 107 instructs reader/encoder 106 to encode information onto the object, which is transmitted also through antenna 203 to the object. The information may comprise a date of manufacture, company name, paving machine type, asphalt mixture parameters, or any other information relating to the particular application for which the inventive principles are applied. For example, the information may relate to detailed engineering parameters associated with a concrete mixture (e.g., type of concrete, date of mixture, company that made the mixture, location, and the like).

More than one antenna may be used, one for reading and the other for encoding. After the information is encoded, computer 107, after verifying the required forward movement distance of the paver, causes indexing gear 202 to rotate, causing the object to exit chamber 205 through an exit chute 204. Exit chute 204 may in turn be coupled to feed tube 104 (FIG. 1) which can then be directed to a particular position within a mixture, such as an area within an asphalt paving machine or a cement mixer or applicator. Additional roadway layers, such as a wearing layer, may be applied after the objects have been embedded and applied.

Indexing gear 202 may be turned by a motor (not shown) whose rate is controlled by computer 107, in order to regulate the flow and thus the distribution density of objects as they are emitted from chamber 205. Other types of mechanisms (e.g., worm gears, conveyor belts, and the like) can also be used and are included within the scope of “indexing gear” and “indexing device” to the extent such terms are used herein.

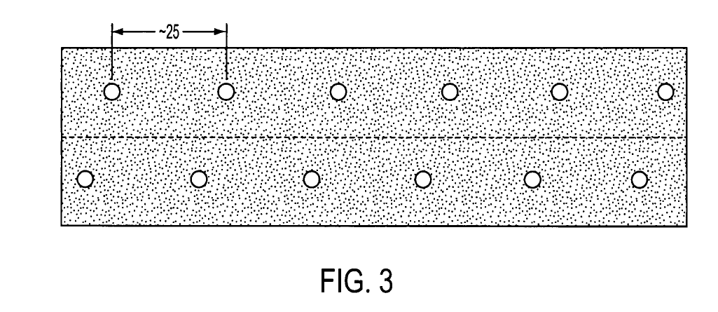

FIG. 3 shows one possible arrangement of transponder spacing in roadway lanes. In one variation, objects are spaced approximately 25 feet apart in the middle of each lane. Other spacings can of course be used based on the application and other factors such as the average speed of vehicles traveling on the roadway. Additionally, objects may be offset from each other in different lanes as shown in FIG. 3. Multiple objects may be embedded next to each other in each lane.

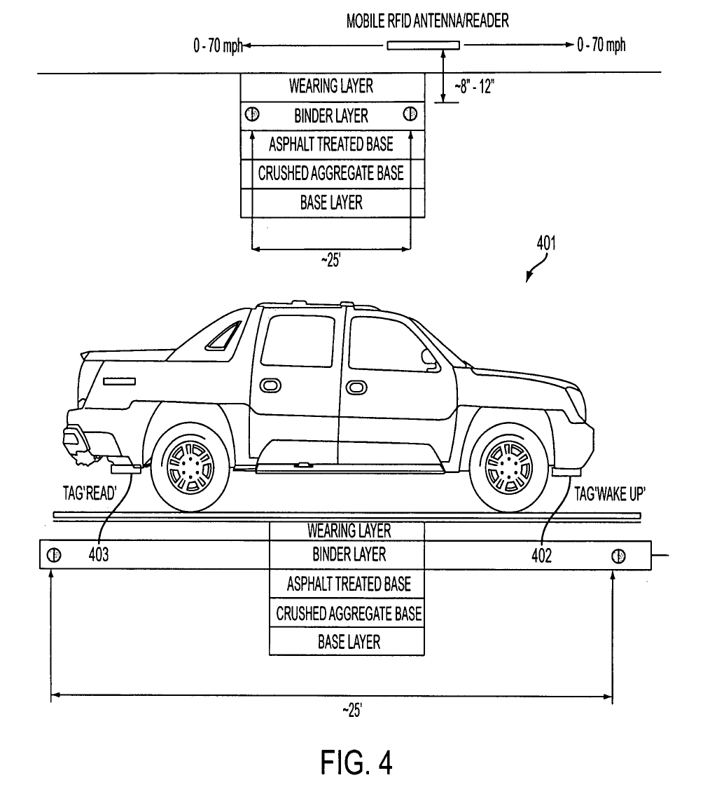

FIG. 4 shows a vehicle 401 equipped with a reader (in the cab of the vehicle) and antennas 402 and 403 for reading and/or encoding data into transponders embedded in a surface, such as a roadway, as well as one possible set of parameters for spacing between antennas and transponders. A first antenna 402 is attached to a front underside of the vehicle and a second antenna 403 is attached to a rear underside of the vehicle, such as at bumper locations. The antennas are coupled to a computer and reader (not shown) located in the vehicle and can be controlled to activate, read, and (optionally) encode data onto RFID transponders embedded in the roadway surface.

As the vehicle traverses the roadway, front antenna 402 issues a “wake-up” signal to transponders embedded in the roadway, and as the rear antenna 403 passes over the transponder, it receives a corresponding output signal from the transponder including information stored thereon. Consequently, as the vehicle travels over the roadway, the computer and reader in the vehicle are able to read data such as the date of manufacture for various segments of the roadway. The computer can store this information for future plotting on a display, download to a server, or other uses.

Many applications for the inventive principles are envisioned. For example, the transponders can be encoded with advertising information (e.g., restaurants, hotels, coupons, sporting information, etc.) and vehicles traveling along a roadway could be presented with such information using readers attached to the vehicles. Such information could be encoded at the time the objects are manufactured, rather than at the time the objects are mixed and embedded in a surface. As another example, a police vehicle could encode objects with current highway conditions or traffic problems (e.g., bridge out ahead or accident ahead).

In one variation, the transponder objects may be embedded in a sub-layer approximately 8 to 12 inches below the antennas, such as in a binder layer of the roadway. The vehicle may travel at various speeds, such as between zero and 70 miles per hour.

Although in some embodiments passive RFID tags are used, in other embodiments active transponders are used (e.g., including a power source such as a battery). In addition to exchanging information with vehicles that pass over the roadway, the transponders may communicate with each other if their spacing permits such communication. Moreover, an embedded roadway network may be constructed such that information is relayed from one transponder to the next along the length of the roadway and extracted by a vehicle or other mechanism (e.g., a stationary reader). Information may also be conveyed from one transponder to the next by having a vehicle read information from one transponder and encode successive transponders along the length of the roadway.

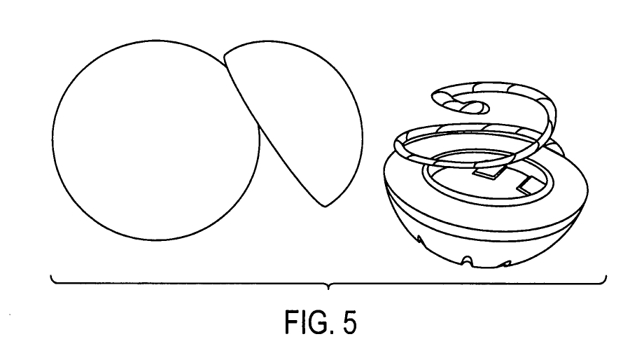

FIG. 5 shows an object suitable for embedding in a surface, such as an asphalt roadway, wherein the object includes a radio frequency transponder and an antenna. The object in FIG. 5 is a prototype showing a dissected solid half-sphere with an RFID tag in the middle portion coupled to a generally helical antenna portion radiating outwardly from the center. (A corresponding antenna element is in the bottom half, not shown). The object may be made in various sizes, such as the size of a golf ball or smaller, such as a marble. The object may also be made of various shapes, such as cubes, disks, coins, or the like. Other examples of object sizes, dimensions, antenna patterns, and connection methods for radio transponders capable of receiving signals in different orientations are illustrated in U.S. patent application Ser. No. 11/527,568, filed on Sep. 27, 2006, again incorporated herein by reference. In one variation, the object may be made of Teflon PTFE. Other exemplary materials include borosilicate, zirconia oxide, machined Ketron PEEK HPV, or RADEL polyphenylsufone.

The antenna may be formed within the object, including an inner surface of the object, or on an outside surface of the object, optionally coated with a protective covering to protect against heat that might impair its operation (e.g., during application with hot asphalt). The object may be solid or hollow.

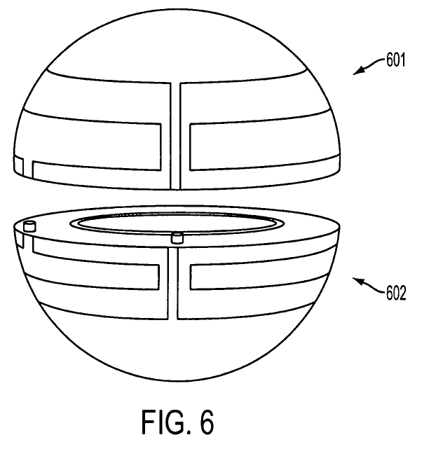

FIG. 6 shows another embodiment of an object suitable for embedding in a surface, wherein the object includes a radio frequency transponder and an antenna pattern that is etched or applied along an outer surface of the object. The object comprises two hemispheres each including an antenna pattern comprising etched wiring or metal foil along the periphery of the hemispheres 601 and 602. The antenna patterns are coupled to the transponder (not shown) through contacts inside the object.

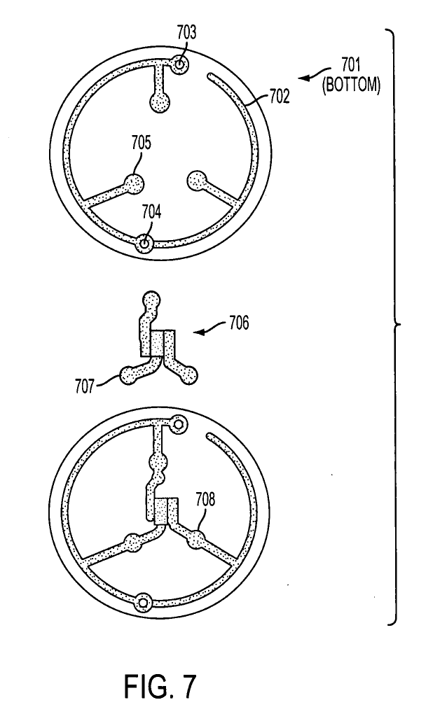

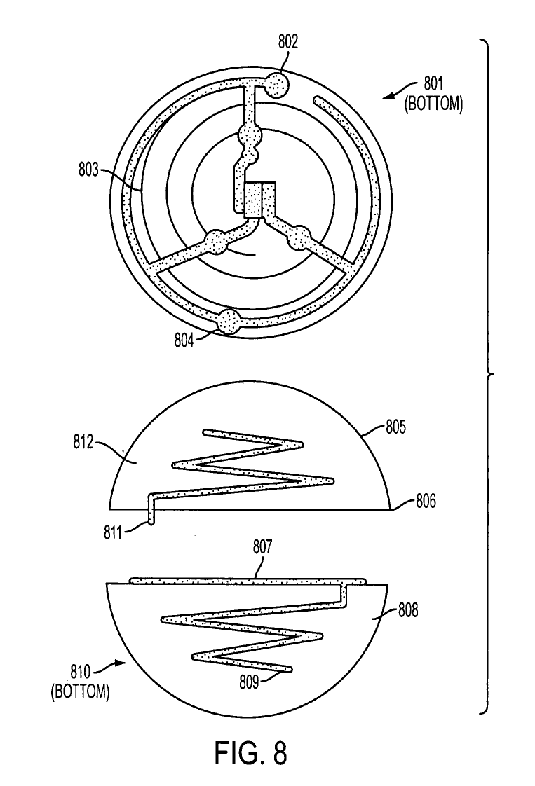

FIGS. 7 and 8 show further details of antenna patterns and coupling mechanisms for coupling the transponder to the antennas according certain variations. Elements 701, 801, and 810 represent a lower hemisphere of a spherical RFID transponder encasement. Elements 702, 802, and 807 represent a resonator inlay applied to the flat surface of the lower hemisphere. Elements 703 and 704 represent an upper antenna coil connection point to the resonator inlay. Elements 802 and 804 represent a lower antenna connection point to the resonator inlay. Elements 705 and 708 represent a Radio Frequency Integrated Circuit (RFIC) staple point to the resonator inlay. Element 706 represents an RFIC with a contact point for a staple to resonator inlay. Elements 707 and 708 represent a staple point to the resonator inlay. Elements 803 and 812 represent an upper antenna coil embedding in the encasement. Element 811 represents the upper antenna connection stub to resonator inlay 802. Element 806 is a heat resistant epoxy application plane. Element 809 is a lower antenna coil embedding in the encasement, and element 808 is the lower antenna coil connection stub to resonator inlay 802. As explained above, the object may be encased in a protective coating after manufacture to prevent heat damage such as might occur during mixing with hot asphalt or concrete.

Because the antennas are arranged in a generally helical pattern or are formed around an outer periphery of the object, the transponders can communicate with readers regardless of the orientation in which they are embedded in a surface, such as a roadway.

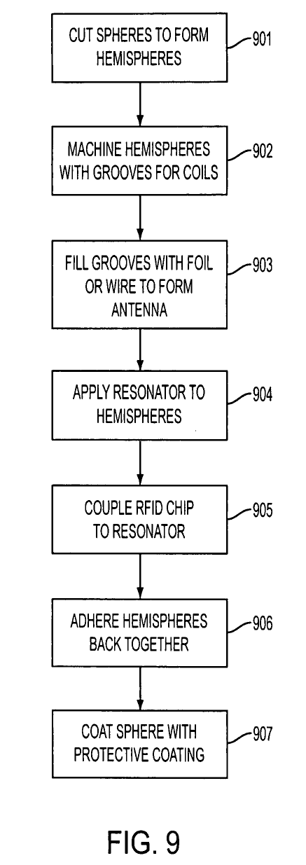

FIG. 9 shows one exemplary first method of creating an object containing a radio frequency transponder and an antenna pattern. In step 901, spheres of a solid material such as TEFLON are cut in half to form hemispheres. The spheres may be machined and cut from a rod. In step 902, each sphere is machined to create grooves for holding antenna elements, such as the helical shaped elements illustrated in FIG. 5. In step 903, the grooves are filled with a foil, wire, or liquid metallic material to form the antennas.

In one variation, instead of machining grooves as in step 902 and filling the grooves with antenna elements as in step 903, a metal-based antenna element may be applied through printing methods or adhered to a surface of the hemispheres as illustrated in FIG. 6.

In step 904, a resonator such as illustrated in FIGS. 7 and 8 is applied, such as through printing or stamping methods, to one of the hemispheres with contact points for the antenna elements and the RFID chip. In step 905, a radio frequency transponder such as an RFID chip is coupled to the resonator and the antenna elements, such as by bonding, glue, stapling or the like.

In step 906, the hemispheres are adhered back to together, and in step 907, the resulting sphere is optionally coated with a protective material such as a resin to prevent heat damage.

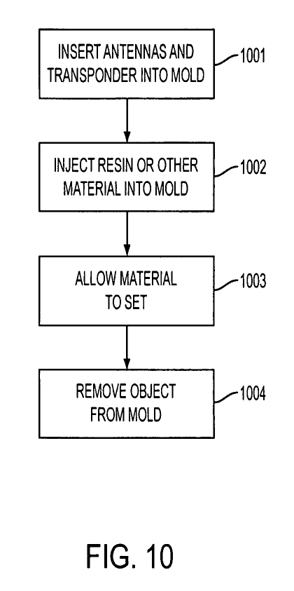

FIG. 10 shows another method of creating an object containing a radio frequency transponder and an antenna pattern according to certain variations of the invention. In step 1001, antennas such as two helical antenna parts of the sort shown in FIG. 5 are formed, coupled to a transponder, and inserted into a mold, such as a spherical or cubic mold. In step 1002, a resin or other material is injected into the mold, and in step 1003 the material is allowed to set. After the material has set, the object is removed from the mold in step 1004. The object may comprise a sphere, cube, or any other shape.

The radio frequency transponders that may be used in different variations of the invention may include various frequencies, such as a low frequency, high frequency or ultra high frequency transmitting signal. Corresponding antennas for the readers can be configured according to the frequency and distance expected from the transponders to the reader antenna. The IC chips can generally handle any tuning that is required on the transponders.

Many variations of the inventive principles. The method steps described herein can be implemented in computer software and encoded on computer-readable media for execution by a computer processor or specialized circuit, and the invention includes such computer-readable media. The use of terms such as “spherical” and “cubic” should be understood to include deviations from such exact shapes. The term “generally solid” includes solids and semi-solids, such as a sphere with a partially hollow core. Method steps should not be considered to be required to be performed in the order in which they are presented unless otherwise indicated.

What is claimed is:

1. A method comprising:
(1) feeding a plurality of objects having radio frequency transponders contained therein into an indexing device;
(2) controlling the indexing device to cause each of the plurality of objects to come into proximity with an antenna capable of reading from and encoding each radio frequency transponder;
(3) causing to be read from each radio frequency transponder identifying information;
(4) causing each radio frequency transponder to be encoded with new information; and
(5) mixing a plurality of objects encoded in step (4) together with a substance.

2. The method of claim 1, wherein step (2) includes the step of controlling the indexing device such that the objects are discharged at a relatively uniform rate.

3. The method of claim 1, further comprising the step of (6) applying the mixed substance including the objects to a surface.

4. The method of claim 3, wherein the surface comprises a roadway and the substance comprises asphalt.

5. The method of claim 3, wherein the surface comprises a roadway and the substance comprises concrete.

6. The method of claim 1, wherein step (4) includes the step of encoding new information indicating one or more parameters associated with the mixing in step (5).

7. The method of claim 6, wherein the new information includes a date of mixing.

8. The method of claim 6, wherein the new information includes asphalt mixture information.

9. The method of claim 1, wherein the objects comprise spheres.

10. The method of claim 1, wherein the objects comprise cubes.

11. The method of claim 1, further comprising the step of applying the mixture such that the objects are embedded in a surface at a depth of approximately between 8 inches and 12 inches from a vehicle-mounted antenna designed to travel over the surface.

12. Apparatus comprising:
a hopper arranged to hold and dispense objects comprising radio frequency transponders;
an indexing device configured to receive objects from the hopper and to bring them in proximity to an antenna;
a radio frequency reader/encoder having an output coupled to the antenna; and
a computer coupled to the indexing device and the radio frequency reader/encoder, wherein the computer is programmed to cause the indexing device and the radio frequency reader/encoder to cooperatively encode the radio frequency transponders.

13. The apparatus of claim 12, wherein the indexing device comprises an indexing gear arranged to controllably move each object toward the antenna under control of the computer.

14. The apparatus of claim 12, wherein the computer controls the indexing device to control a rate at which objects are moved toward the antenna.

15. The apparatus of claim 12, further comprising a mixing chamber arranged to receive objects having encoded radio frequency transponders from the indexing device and mix them with a substance.

16. The apparatus of claim 15, wherein the mixing chamber is configured to mix the objects with asphalt.

17. The apparatus of claim 15, wherein the mixing chamber is configured to mix the objects with concrete.

18. The apparatus of claim 12, wherein the indexing device is configured to receive spherical objects and discharge them through a feed tube.

19. The apparatus of claim 12, further comprising a paving machine configured to receive the objects, mix them with asphalt, and apply them to a roadway surface.

20. A generally solid object comprising a radio frequency transponder and two helical antenna elements embedded in the generally solid object.

21. The object of claim 20, wherein the object has a generally spherical shape.

22. The object of claim 20, wherein the object has a generally cubic shape.

23. The object of claim 20, wherein the radio frequency transponder is encoded with advertising information.

24. A generally spherical object having a first antenna pattern formed around a first portion thereof and a second antenna formed around a second portion thereof, the generally spherical object further including a radio frequency transponder coupled to the first and second antenna patterns, and a protective coating encasing the first and second antenna patterns.

25. The object of claim 24, wherein the radio frequency transponder is programmed with advertising information.

26. A method comprising:
(1) forming an antenna element in each of two generally solid hemispheres;
(2) coupling a radio frequency transponder to each antenna element;
(3) adhering the two hemispheres to form a sphere; and
(4) coating the sphere with a protective coating.

27. The method of claim 26, wherein step (1) includes the step of machining grooves into each generally solid hemisphere.

28. The method of claim 26, wherein step (1) comprises the step of forming a generally helical antenna element in each generally solid hemisphere.

29. The method of claim 26, wherein step (1) comprises the step of forming a foil pattern on a surface of each generally solid hemisphere.

30. A method comprising:
(1) inserting two antenna elements and a radio frequency transponder coupled thereto into a mold;
(2) injecting a hardening substance into the mold;
(3) allowing the hardening substance to harden; and
(4) removing the resulting product from the mold.

31. The method of claim 30, wherein the mold comprises a generally spherical shape.

32. The method of claim 30, wherein the mold comprises a generally cubical shape.

33. A vehicle comprising a first antenna unit arranged to travel at a generally fixed distance above a surface, a second antenna arranged to travel at the generally fixed distance above the surface, and a computer and reader configured to control the first and second antennas to cause the units to read encoded radio frequency transponders embedded in the surface.

34. The vehicle of claim 33, wherein the first antenna is arranged near a front end of the vehicle and the second antenna is arranged near a read end of the vehicle.

35. The vehicle of claim 33, wherein the computer and reader are configured to encode radio frequency transponders, through the antennas, with information as the vehicle travels over the surface.

36. The vehicle of claim 35, wherein the information concerns dynamic roadway conditions.

37. The vehicle of claim 35, wherein the information concerns traffic conditions.

38. The vehicle of claim 35, wherein the information comprises advertising information.
